(19) United States
(12) Patent Application Publication
(10) Pub. No.: US 2010/0253858 A1
(43) Pub. Date: Oct. 7, 2010

(54) SYSTEM AND METHOD FOR TUNING AN ELECTRONIC DEVICE

(75) Inventor: Mark Nierzwick, Brownsburg, IN (US)

Correspondence Address: FLETCHER YODER P.C., 7915 FM 1960 RD. WEST, SUITE 330, HOUSTON, TX, 77070, US

(73) Assignee: SHENZHEN TCL NEW TECHNOLOGY LTD., Shekou, Shenzhen, Guangdong (CN)

(21) Appl. No.: 12/746,111

(22) PCT Filed: Oct. 27, 2008
(86) PCT No.: PCT/US08/81352

§ 371 Date: Jun. 3, 2010

(30) Foreign Application Priority Data
Dec. 25, 2007 (CN) 200710125505.0

(51) Int. Cl. H04N 5/50

(52) U.S. Cl. 348/732; 348/E05.097

(57) ABSTRACT

There is provided a system and method for tuning an electronic device. More specifically, in one exemplary embodiment, there is provided a method comprising maintaining a modulation type search order list of a plurality of modulation types and periodically re-ordering the modulation type search order list based on a first specified number of most recently tuned channels. The exemplary method further comprises tuning a requested channel whose modulation type is not known by selecting a one of the plurality of modulation types in order from the modulation type search order list until a modulation type corresponding to the requested channel is determined.

### BACKGROUND

This section is intended to introduce the reader to various aspects of art which may be related to various aspects of embodiments of the present invention that are described below. This discussion is believed to be helpful in providing the reader with background information to facilitate a better understanding of the various aspects of embodiments of the present invention. Accordingly, it should be understood that these statements are to be read in this light, and not as admissions of prior art.

Digital televisions must search several modulation types when attempting to tune a channel. Examples of modulation types used in digital cable systems include quadrature amplitude modulation (QAM) (for example, QAM64, QAM256, 64QAM HRC, 256QAM HRC), vestigial sideband modulation (VSB) (for example, 8-VSB, 8-VSB HRC), NTSC, NTSC HRC or the like. Various specific channels also have special requirements such as incrementally related carrier (IRC) and ultra-high frequency (UHF) offsets and non-standard frequencies. A digital television must implement an algorithm to search the various modulation types to find the modulation type being used for the channel of interest and produce demodulated video and audio for the user.

Existing televisions typically store the most recent successful modulation type for each channel in memory and begin with that type to speed up the perceived tune time. Also, if no previous modulation type exists for a given channel, the last successful tune of any channel may be used as a starting point in the search through all the modulation types.

A user may perceive the time to tune a desired channel as poor performance by the television if the correct modulation type is not quickly determined. An improved system and method for determining the correct modulation type for a channel tuned by a user is desired.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention; and

FIG. 2 is a flow chart representing a method in accordance with one exemplary embodiment of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

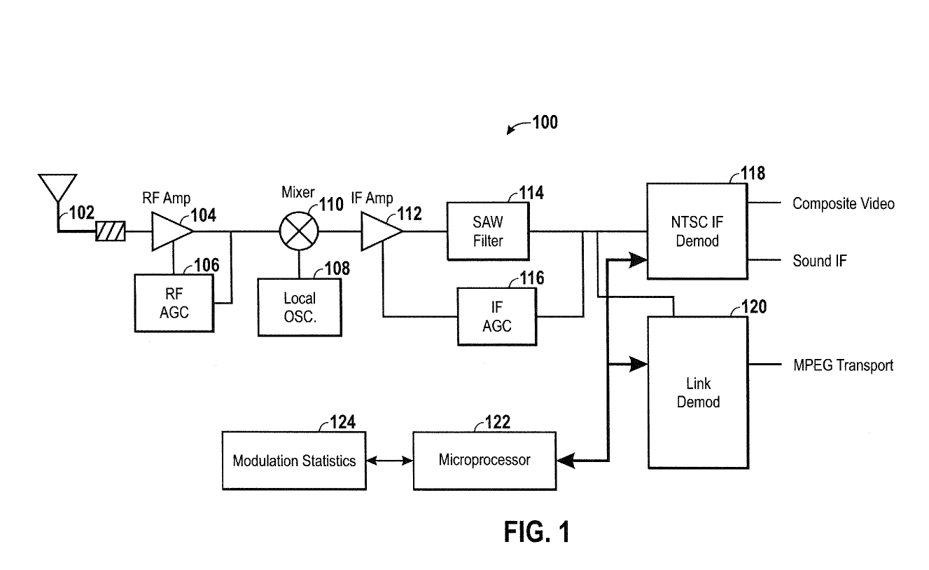

FIG. 1 is a block diagram of an electronic device 100 in accordance with an exemplary embodiment of the present invention. The electronic device 100 (for example, a tuner for a television, a digital TV receiver, a set-top box or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

In the exemplary embodiment shown in FIG. 1, the functional blocks include a receptor 102. In one exemplary embodiment, the receptor 102 comprises an antenna able to receive a signal comprising a plurality of broadcast channels. Conversely, the receptor 102 may be a port that receives signals from a variety of input sources such as a cable inlet, a satellite source, or a direct subscriber line (“DSL”). The electronic device 100 also includes a radio frequency (RF) amplifier 104, which amplifies the received signals, and a radio frequency automatic gain controller (RF AGC) 106. The RF AGC 106 may automatically control the gain imparted to the received signals by use of a feedback loop to, for example, keep the output power of the received signals constant.

The electronic device 100 also includes a local oscillator 108, which may generate signals at desired oscillation frequencies corresponding to particular channels selected. These signals of a desired frequency selected are sent to a mixer 110, which mixes the oscillator signals with the signals from the RF amplifier 104 to create mixed frequency signals. The mixed frequency signals are then sent to an intermediate frequency (IF) amplifier 112.

The IF amplifier 112 amplifies the mixed frequency signals received from the mixer 110. These amplified signals then pass through a surface acoustic wave (SAW) filter 114, which operates to pass through desired signals while filtering (blocking) undesired signals. The IF amplifier 112 and the SAW filter 114 work in conjunction with the IF automatic gain controller (IF AGC) 116. The IF AGC 116 may automatically control the gain imparted by the IF amplifier 114 by using a feedback loop to, for example, keep the output power of the SAW filtered signals constant.

The electronic device 100 also includes a National Television System Committee IF demodulator (NTSC IF DEMOD) 118, as well as a link demodulator (LINK DEMOD) 120. The NTSC IF DEMOD 118 demodulates the SAW filtered signals to transmit analog television signals in the form of composite video signals and sound signals to a display. The LINK DEMOD 120 demodulates the SAW filtered signals to transmit digital television signals in the form of MPEG (Moving Picture Experts Group) transport signals. In one exemplary embodiment, the MPEG transport signals are MPEG-2 signals.

The electronic device 100 further includes a microprocessor 122, which controls the operation of the NTSC IF DEMOD 118 as well as the LINK DEMOD 120. In one exemplary embodiment, the microprocessor 122 operates to activate the NTSC IF DEMOD 118 when an analog television signal is to be displayed on a display. In another exemplary embodiment, the microprocessor 122 operates to activate the LINK DEMOD 120 when a digital television signal is to be displayed on a display. In another exemplary embodiment, the microprocessor 122 may be coupled to a tangible, machine-readable medium (such as a memory) that may be adapted to hold machine-readable computer code that causes the processor to perform operations in accordance with an exemplary embodiment of the present invention. An example of a tangible machine-readable memory is a modulation statistics storage device 124, which is connected to the microprocessor 122.

In one exemplary embodiment, the modulation statistics storage device 124 is a non-volatile storage device such a disk drive, flash memory, EPROM, EEPROM or the like. In a further embodiment, the modulation statistics storage device 124 may include multiple storage devices. The modulation statistics storage device 124 is used to store information relating to the likelihood (based on past successful tunings) that a particular modulation type will be correct for a channel whose modulation type is not known. In one exemplary embodiment, a modulation type search order list of all modulation types to be searched is stored in the modulation statistics storage device 124. The modulation types to be tried may include, for example, QAM64, QAM256, 8-VSB, NTSC, 64QAM HRC, 256QAM HRC, 8-VSB HRC, NTSC HRC, or the like. The modulation type search order list may be initially assembled in a default search order.

In an exemplary embodiment of the present invention, a list of the most recently successful modulation types used to tune each of a specific number of most recently tuned channels is also maintained. As set forth below, in one exemplary embodiment of the present invention, the microprocessor 122 periodically reorders the modulation type search order list based on statistics relating to the most recent successful modulation types.

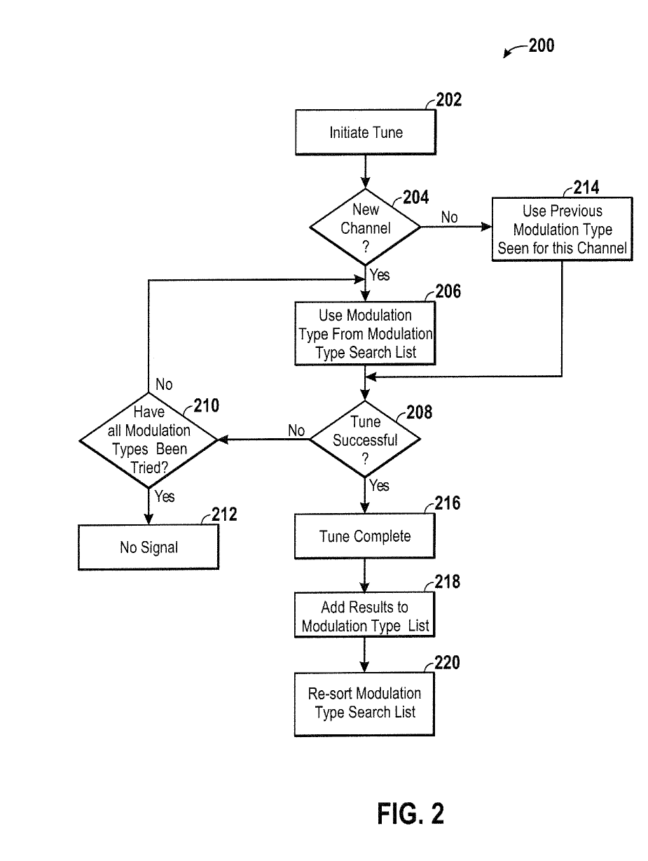

FIG. 2 is a flow chart representing a process in accordance with one exemplary embodiment of the present invention. The process is generally indicated by reference numeral 200. The process 200 is an exemplary embodiment of the use of modulation statistics located in the modulation statistics storage device 124 for tuning a channel. Such a process may be performed by the electronic device 100, as carried out by the microprocessor 122.

At block 202, the process begins when a tune is initiated. Initiating a tune may include turning a television device on or changing the channel on a currently operating television. In one exemplary embodiment, while initiating a tune when a digital television is first installed, information corresponding to each channel must be discovered by performing an automatic channel scan or by manually selecting each channel.

At block 204, the microprocessor 122 determines if the channel to be tuned is a new channel (i.e., a channel that has never been previously tuned by this television). If the channel has been previously tuned, the modulation type that was successful for the previous tune is applied, as shown at block 214. Process flow then continues to block 216, as is described below.

If, at block 204, it is determined that the desired channel has not been previously tuned, the microprocessor 122 attempts to tune the channel by applying modulation types from the current modulation type search order list in order until the correct modulation type is found. The order in which the modulation types appear in the modulation type search order list is based on modulation statistics stored in the modulation statistics storage device 124.

Every time a channel is tuned, the modulation type used is noted and stored in the modulation statistics storage device 124. The data regarding the modulation types of successful tunes may be maintained as a recently successful modulation type list. In one exemplary embodiment, the modulation statistics storage device 124 contains statistics about how frequently different modulation types have been successful used to tune previous channels. These statistics are used to periodically reorder the modulation type search order list specifying the order in which modulation types are applied when tuning new channels (i.e., channels whose modulation type is not known because they have never been tuned).

The ordering of the modulation type search order list may take into account a fixed number of previous tunes (for example, the past 20 tunes). This strategy assumes that the most recent data is the most likely to result in the correct modulation type being applied. In addition, more recent tunes may be weighted more heavily than less recent tunes within the fixed number of previous tunes. For example, the list of recently successful tunes may be weighted in determining whether to change the modulation type search order list such that the five most recently tuned channels have more weight than the previous 15 in determining the order in which modulation types are applied. In another exemplary embodiment, various modulation types may be weighted more highly than others based on the speed in which the modulation type can be tuned. For example, since standard NTSC modulation types are generally faster than other modulation types, the NTSC modulation types could have a higher weighting that would result in placement of NTSC higher (earlier) in the modulation type search order list.

At block 206, the microprocessor 122 applies the next modulation type from the current modulation type search order list stored in the modulation statistics storage device 124. At block 208, the microprocessor 122 determines if the applied modulation type for the tune was correct. The modulation type is correct if it corresponds to the modulation type of the channel that is being tuned, resulting in the desired channel being correctly tuned. If the modulation type tried is determined to be incorrect, a determination is made regarding whether all modulation types in the list have been tried at block 210. If all modulation types have been tried, no signal is present on the desired channel, as shown at block 212. The user may be notified that there is no signal on the desired channel.

If, at block 210, all modulation types from the modulation type search order list have not been tried, process flow continues to block 206, where the next modulation type from the modulation type search order list is tried. The microprocessor 122 then determines if the most recent modulation type was correct. If not, additional iterations continue with different modulation types being selected in the order they appear in the current modulation type search order list. When the correct modulation type is applied, the tuning operation is completed, as shown at block 216.

When a successful tune is accomplished (block 216), the microprocessor 122 adds the modulation type that was successful to the list of recently successful modulation types at block 218. At block 220, the modulation type search order list is re-sorted to take into account the most recently successful modulation type. As set forth above, the most recently successful modulation type may be more heavily weighted depending on system design considerations. In one exemplary embodiment, the re-sorting of the modulation type search order list includes ordering the modulation types based on the number of times each modulation type has been most recently successful. In such an embodiment, the modulation type search order list is thus re-sorted to start with the most frequently used modulation type in highest position in the search list, followed by the second most frequently used modulation type in the second highest position in the modulation type search order list, and so forth. Another exemplary embodiment includes sorting the modulation types based on frequency statistics and at least one weight factor, such as the speed in which the modulation type can be tuned.

While the present techniques may be susceptible to various modifications and alternative forms, specific embodiments have been shown by way of example in the drawings and are described in detail herein. However, it should be understood that the techniques are not intended to be limited to the particular forms disclosed. For example, with regard to the processes discussed above, the user queries may be optional and may be asked or omitted depending on design. Further, certain aspects of the disclosed processes may be performed in an order different than that illustrated. It should be noted that the disclosed techniques are to cover all modifications, equivalents and alternatives falling within the spirit and scope of the techniques as defined by the following appended claims.

What is claimed is:

1. A method of operating an electronic device, the method comprising:
maintaining a modulation type search order list of a plurality of modulation types;
periodically re-ordering the modulation type search order list based on a first specified number of most recently tuned channels; and
tuning a requested channel whose modulation type is not known by selecting a one of the plurality of modulation types in order from the modulation type search order list until a modulation type corresponding to the requested channel is determined.

2. The method of claim 1, wherein periodically re-ordering the modulation type search order list comprises weighting the modulation types more heavily based on a second specified number of most recently tuned channels, the second specified number being less than the first specified number.

3. The method of claim 2, wherein the first specified number is 20.

4. The method of claim 2, wherein the second specified number is five.

5. The method of claim 1, wherein periodically re-ordering the modulation type search order list comprises weighting the modulation types more heavily based on a speed of tuning a particular modulation type.

6. The method of claim 1, wherein tuning the requested channel comprises employing a modulation type previously associated with the requested channel when the requested channel has been previously tuned by the electronic device.

7. The method of claim 1, comprising adding the modulation type corresponding to the requested channel to a recent modulation type list.

8. The method of claim 7, wherein periodically re-ordering the modulation type search order list comprises employing data from the recent modulation type list.

9. The method of claim 1, comprising tuning the requested channel during an initial setup sequence by employing successive modulation types from the modulation type search order list until a modulation type corresponding to the requested channel is determined.

10. The method of claim 1, wherein the modulation type search order list comprises QAM64, QAM256, 8-VSB, NTSC, 64QAM HRC, 256QAM HRC, 8-VSB HRC and NTSC HRC.

11. An electronic device, comprising:
a signal source input adapted to receive a signal comprising a plurality of broadcast channels; and
a processor adapted to:
maintain a modulation type search order list of a plurality of modulation types corresponding to recently tuned channels;
periodically re-order the modulation type search order list based on a first specified number of most recently tuned channels; and
tune a requested channel whose modulation type is not known by selecting a one of the plurality of modulation types in order from the modulation type search order list until a modulation type corresponding to the requested channel is determined.

12. The electronic device of claim 11, wherein periodically re-ordering the modulation type search order list includes weighting the modulation types more heavily based on a second specified number of most recently tuned channels, the second specified number being less than the first specified number.

13. The electronic device of claim 12, wherein the first specified number is 20.

14. The electronic device of claim 12, wherein the second specified number is 5.

15. The electronic device of claim 11, wherein periodically re-ordering the modulation type search order list comprises weighting the modulation types more heavily based on a speed of tuning a particular modulation type.

16. The method of claim 11, wherein the processor is adapted to tune the requested channel by employing a modulation type previously associated with the requested channel when the requested channel has been previously tuned by the electronic device.

17. The electronic device of claim 11, wherein the processor is adapted to add the modulation type corresponding to the requested channel to a recent modulation type list.

18. The electronic device of claim 17, wherein the processor is adapted to periodically re-order the modulation type search order list using data from the recent modulation type list.

19. The electronic device of claim 11, wherein the processor is adapted to tune the requested channel during an initial setup sequence by employing successive modulation types from the modulation type search order list until a modulation type corresponding to the requested channel is determined.

20. An electronic device, comprising:
means for maintaining a modulation type search order list of a plurality of modulation types;
means for periodically re-ordering the modulation type search order list based on a first specified number of most recently tuned channels; and
tuning a requested channel whose modulation type is not known by selecting a one of the plurality of modulation types in order from the modulation type search order list until a modulation type corresponding to the requested channel is determined.
